(19) United States
(12) Patent Application Publication
(10) Pub. No.: US 2007/0219912 A1
(43) Pub. Date: Sep. 20, 2007

(54) Information distribution system, information distribution method, and program product for information distribution

(75) Inventors: Kentaro Takano, Tokyo (JP); Suguru Mizunashi, Kanagawa (JP)

Correspondence Address: OLIFF & BERRIDGE, PLC, P.O. BOX 19928, ALEXANDRIA, VA, 22320, US

(73) Assignee: FUJI XEROX CO., LTD., Tokyo (JP)

(21) Appl. No.: 11/505,458

(22) Filed: Aug. 17, 2006

(30) Foreign Application Priority Data
Mar. 6, 2006 (JP) 2006-058786

(51) Int. Cl. H04L 9/00

(52) U.S. Cl. 705/51

(57) ABSTRACT

An information distribution system includes a selecting unit that selects distribution information to be distributed to a user from stored information that is stored in compliance with distribution standards, a distributing unit that distributes the distribution information selected by the selecting unit, to the user, a receiving unit that receives a viewing status information that indicates a viewing status of the user who is viewing the distribution information, an evaluating unit that evaluates the suitability of the distribution information, based on the viewing status information, and a changing unit that changes the distribution standards, based on results of the evaluation performed by the evaluating unit.

### BACKGROUND

1. Technical Field

The present invention generally relates to an information distribution system and an information distribution method.

2. Related Art

There have been proposed multimedia information systems. In the multimedia information systems, the images and sounds of conferences, lectures, live shows, live sporting events, and any other live information are recorded, and multimedia information is automatically produced based on the recorded information. The multimedia information is distributed to users and participants who are registered in advance.

### SUMMARY

An aspect of the present invention provides an information distribution system including: a selecting unit that selects distribution information to be distributed to a user from stored information that is stored in compliance with distribution standards; a distributing unit that distributes the distribution information selected by the selecting unit, to the user; a receiving unit that receives a viewing status information that indicates a viewing status of the user who is viewing the distribution information; an evaluating unit that evaluates the suitability of the distribution information, based on the viewing status information; and a changing unit that changes the distribution standards, based on results of the evaluation performed by the evaluating unit.

### BRIEF DESCRIPTION OF THE DRAWINGS

Embodiments of the present invention will be described in detail based on the following figures, wherein:

FIG. 1 illustrates the entire structure of an information distribution system in accordance with an embodiment of the present invention;

FIG. 2 illustrates the structure of the information record distribution device;

FIG. 3 illustrates the structure of the distribution information selecting unit;

FIG. 4 illustrates the structure of the user terminal;

FIG. 5 shows the flow of the operation to be performed to register conference data, captured by the presentation system, in the information record distribution device;

FIG. 6 shows the flow of the operations to be performed by the information record distribution device and the user terminal;

FIG. 7 is a flowchart of the operation to be performed when the user registers viewing status information;

FIG. 8 is a flowchart of the operation to be performed when the user deletes viewing status information;

FIG. 9 illustrates the automatic evaluation by the distribution information evaluating unit; and

FIG. 10 illustrates the hardware structure of an information record distribution device.

### DETAILED DESCRIPTION

A description will now be given, with reference to the accompanying drawings, of embodiments of the present invention.

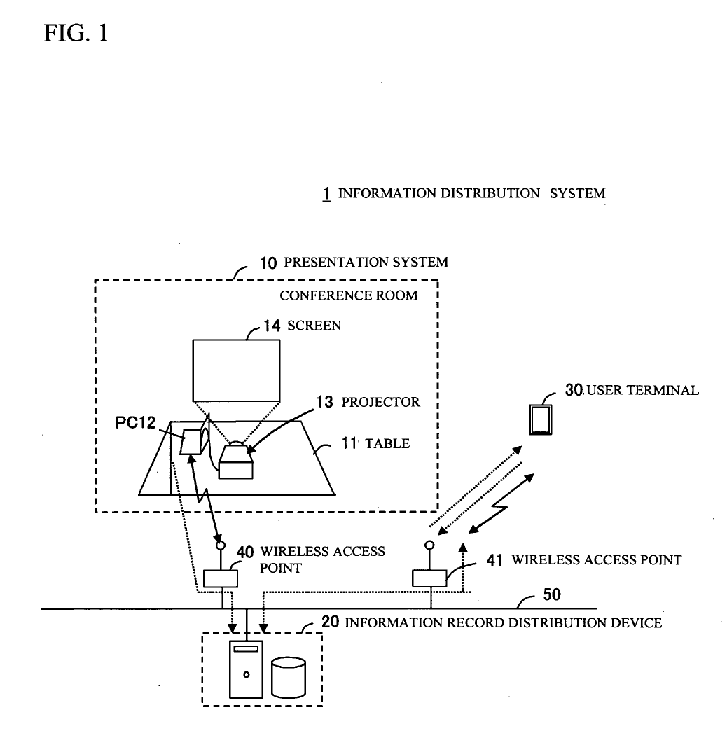

FIG. 1 shows the entire structure of the information distribution system in accordance with the embodiment of the present invention. This information distribution system 1 includes a presentation system 10, an information record distribution device 20, and a user terminal 30. The information distribution system 1 performs operations such as automatic recording of conferences, automatic summarization of recorded conference information, and notification and distribution to users. The presentation system 10 includes a personal computer (PC) 12 placed on a conference table 11, a projector 13, and a screen 14.

The presentation system 10 and the user terminal 30 are connected to a network 50 with wireless access points 40 and 41. This network 50 is a private network or an in-house LAN. The network 50 may be formed with cables, radios, or communication lines including both cables and radios. The presentation system 10 and the user terminal 30 may be connected to the network 50 with wires.

The presentation system 10 supports conferences and presentations (hereinafter referred to simply as “conferences”) and captures conference data (accumulated information). The presentation system 10 sends the captured conference data to the information record distribution device 20. Although only one presentation system 10 is shown in FIG. 1, two or more presentation systems may be employed in a case where two or more conference rooms exist. In such a case, one presentation system is provided in each one conference room.

The information record distribution device 20 accumulates conference data that is received from the presentation system 10. The information record distribution device 20 processes the accumulated conference data, and transmits the processed data to the user terminal 30 by a push technique.

The user terminal 30 is a mobile terminal such as a notebook computer or a portable telephone. The user terminal 30 receives distribution data distributed by the information record distribution device 20, and displays the distribution data. In FIG. 1, only one user terminal exchanges data with the information record distribution device 20. In reality, however, two or more user terminals can exchange data with the information record distribution device 20.

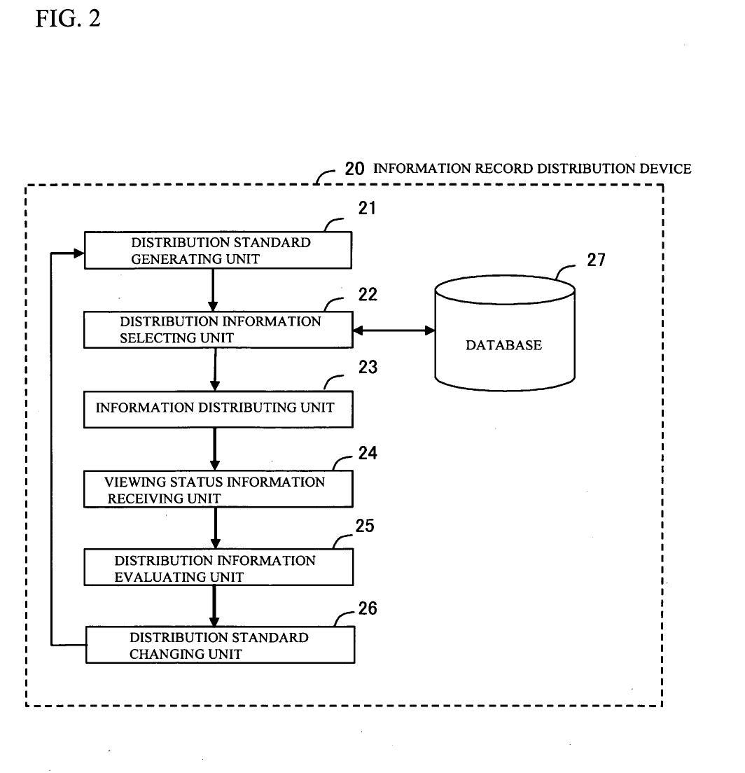

Next, the information record distribution device 20 is described. FIG. 2 illustrates the structure of the information record distribution device 20. As shown in FIG. 2, the information record distribution device 10 includes a distribution standard generating unit 21, a distribution information selecting unit 22, an information distributing unit 23, a viewing status information receiving unit 24, a distribution information evaluating unit 25, a distribution standard changing unit 26, and a database 27.

The distribution standard generating unit 21 generates the distribution standards, based on registration information that is registered by the user. For example, the user can register the registration information in the information record distribution device 20 through the user terminal 30. The distribution standard information may be registered by the user or selected by the user. The distribution standard information is registered by arbitrarily setting one or more elements from image, audio, and text information. The distribution standard information contains the keyword characters, the texts and images of conference materials, the text and images of multimedia minutes, and the audio information of recorded conferences, for example.

Here, the keyword is formed with a single word, for example. The keyword may be a phrase or a sentence. The conference materials are used and distributed in conferences, and contain characters or images. The multimedia minutes contain audio data of conferences and the likes, and may be audio data or texts written based on audio data by a speech recognition technique.

In a case where selections are made by the user, when the user sends a conference material to the information record distribution device 20 via the user terminal 30, for example, the information record distribution device 20 OCRs and classifies the conference material into text information, diagram information, and layout information, which are presented to the user via the user terminal 30. The user then operates the user terminal 30 to select one or more elements from text, audio, and image elements. The user sets priorities to those elements and registers the prioritized elements. For example, indexing may be performed by detecting scenes and extracting characteristic images from a moving image (see Japanese Patent Application Publication No. 2003-179849, for example), and the indexed images may be registered as registration information. The technique of indexing images is disclosed in Japanese Patent Application Publication No. 2003-179849, for example.

The distribution information selecting unit 22 selects the data to be distributed to users from the conference data accumulated in the database 27 in compliance with the distribution standard generated by the distribution standard generating unit 21.

The information distributing unit 23 distributes distribution data that is determined to be distributed, to distribution destinations that is determined to receive the distribution data by the distribution information selecting unit 22. For example, the information distributing unit 23 performs the distribution of the data by distributing a notification of the storage place of the distribution data or adding the distribution data. The storage place of the distribution data may be notified by sending a URL (Uniform Resource Locator), for example. The distribution data may be in a SWF (Small Web Format) or a HTML (HyperText Markup Language), or a moving image. With the use of a HTML, image and voice embedding, simultaneous reproduction in a SMIL (Synchronized Multimedia Integration Language), or the like can be realized.

The distribution information to be distributed by the information distributing unit 23 includes not only conference data such as conference images, conference voices, and conference materials, but also data obtained by processing the conference data in several ways, such as summary data obtained by summarizing the conference data, text data obtained by writing down the audio data of the conference data, the summary data of the text data, the audio data of the conference data, and the summary data of the audio data.

The viewing status information receiving unit 24 receives viewing status information from the user terminal 30. The viewing status information indicates the viewing status of the user who is viewing the distribution data. The distribution information evaluating unit 25 evaluates the suitability of the distribution data, based on the viewing status information received from the user terminal 30. For example, the distribution information evaluating unit 25 calculates the screen display portions of a view-point stop spot, a partially enlarged viewer stop point, and an enlarged display UI. If the calculated values are larger than predetermined values, the distribution information evaluation unit 25 determines that the user has eagerly viewed the distribution data.

The distribution standard changing unit 26 changes the distribution standard, based on the results of the evaluation made by the distribution information evaluating unit 25. More specifically, the distribution standard changing unit 26 changes the weightings (w1, w21, w22, w2, . . . ) for the elements that affects whether to distribute the data. The changes of the weightings may be performed by a known method involving a neural network or the like. Since a large number of learning times cannot be expected, each change should be made larger, and the parameters should be shared among the members of a group or a division. Here, the weightings may be changed, with the time required for determining and evaluating the identity of each member being taken into consideration (see Japanese Patent Application Publication No. 2005-130257).

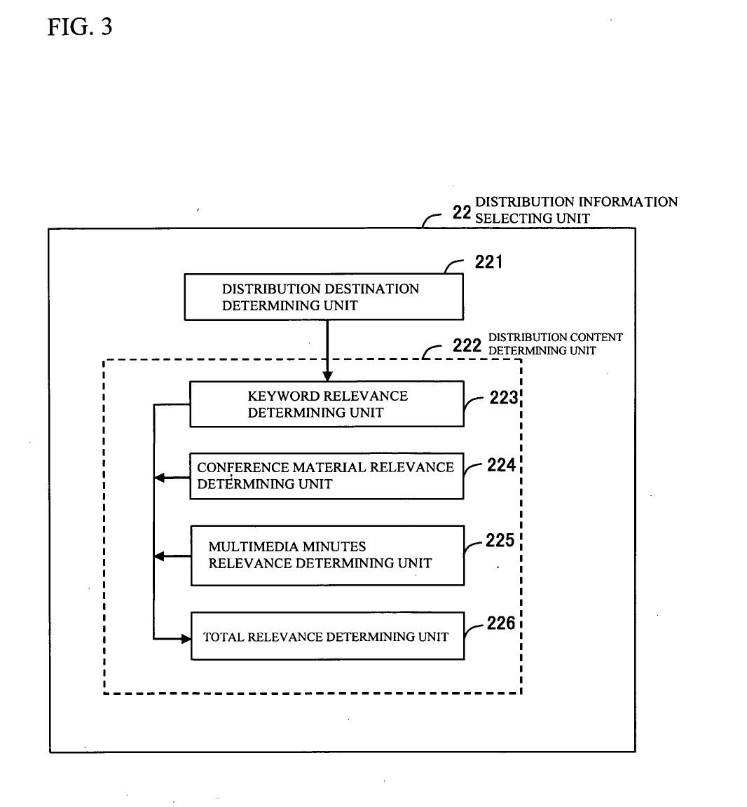

Next, the distribution information selecting unit 22 is described. FIG. 3 illustrates the structure of the distribution information selecting unit 22. The distribution information selecting unit 22 includes a distribution destination determining unit 221 and a distribution content determining unit 222. The distribution destination determining unit 221 refers to distribution destination information and the attributes of the accumulated conference data, so as to determine whether the subject destination is a distribution destination. The distribution destination information is the user's personal information, such as the mail address, the telephone number, the user attributes, and the likes for designating the distribution destination. Here, the user attributes include the names of the company, the division, and the position. The attributes of the conference data include the conference room information, secret information, and the distributable range information.

The distribution content determining unit 222 determines whether to perform distribution, based on the contents of the recorded conference data. This distribution content determining unit 222 includes a keyword relevance determining unit 223, a conference material relevance determining unit 224, a multimedia minutes relevance determining unit 225, and a total relevance determining unit 226.

The keyword relevance determining unit 223 determines the relevance of each keyword in compliance with the distribution standards. The keyword relevance determining unit 223 determines the degree of association between the keyword registered by the user in compliance with the distribution standards and the text information obtained by performing an OCR operation on the conference materials contained in the conference data stored in the database 27 or the text information obtained by performing a speech recognizing operation on the conference speeches. The keyword relevance determining unit 223 determines the relevance of the keyword by checking the degree of association between the keyword and such text information by a known relevant document search technique.

The conference material relevance determining unit 224 determines the relevance of the conference materials in compliance with the distribution standards. The conference material relevance determining unit 224 determines the relevance of each element or several elements of the text information, the image information, the layout information, and the likes contained in the conference materials consisting of images and texts. Based on the determination results, the conference material relevance determining unit 224 performs weighting (w21, w22, w23, . . . ). The conference material relevance determining unit 224 may use a known image recognition technique, a known relevant document search technique, or the like in determining the relevance of elements.

The multimedia minutes relevance determining unit 225 determines the relevance of the multimedia minutes in compliance with the distribution standards. Using distributed multimedia minutes that have been distributed in the past, the multimedia minutes relevance determining unit 225 searches the relevant multimedia minutes. For the conference speeches, each speaker is identified through voice printing, and the contents of each speech are determined through speech recognition. As in the conference material relevance determination, the multimedia minutes relevance determining unit 225 determines the relevance of each element or several elements, and performs weighting (w31, w32, w33, . . . ).

Te total relevance determining unit 226 performs weighting (w1, w2, and w3) for the relevance determined by the keyword relevance determining unit 223, the relevance determined by the conference material relevance determining unit 224, and the relevance determined by the multimedia minutes relevance determining unit 225. If those relevance values are larger than the respective threshold values, the conference data is set for distribution.

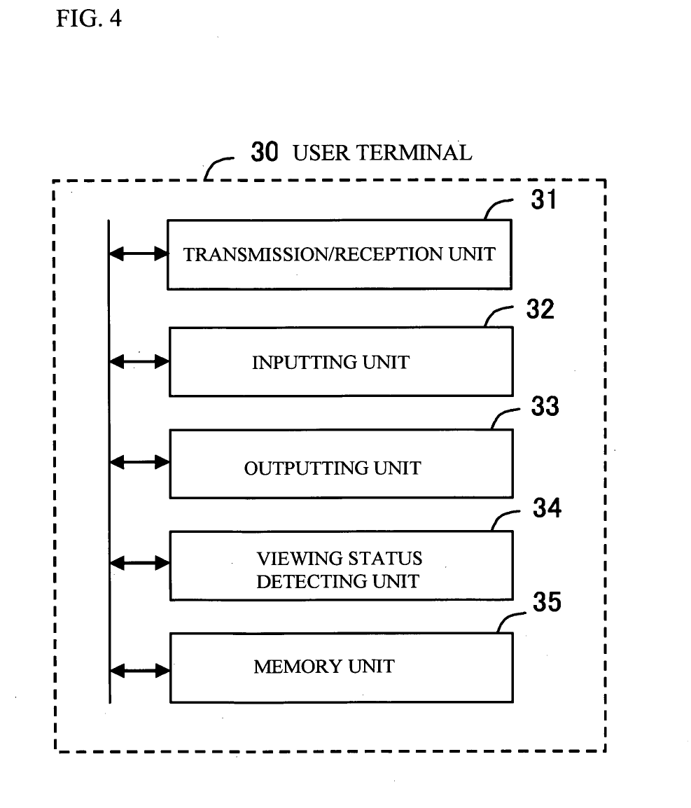

FIG. 4 illustrates the structure of the user terminal 30. As shown in FIG. 4, the user terminal 30 includes a transmission/reception unit 31, an inputting unit 32, an outputting unit 33, a viewing status detecting unit 34, and a memory unit 35. The transmission/reception unit 31 transmits the registration information to the information record distribution device 20, receives the distribution data from the information distributing unit 23 of the information record distribution device 20, and transmits the viewing status information detected by the viewing status detecting unit 34 to the information record distribution device 20.

The inputting unit 32 is formed with a keyboard, for example, and inputs the registration information and the viewing status information to be registered in the information record distribution device 20. The inputting unit 32 may input a viewing status by a speech recognition technique, based on audio data gathered through a microphone. The outputting unit 33 is formed with a display or a speaker. The outputting unit 33 displays distribution data distributed from the information record distribution device 20, or reproduces the distribution data based on audio data. Accordingly, the user can view the conference video and listens to the conference speeches.

The viewing status detecting unit 34 detects the viewing status of the user who is viewing the distribution data. For example, the viewing status detecting unit 34 detects, as the viewing status information, the display time of the images contained in the distribution data, the reproduction time of the audio information contained in the distribution data, the biologic information as to the user viewing the distribution data, or the operation status information of the user terminal 30 reproducing the distribution data. The memory unit 35 stores the distribution data received by the transmission/reception unit 31.

In a case where an interface for partially enlarging an image (see Japanese Patent Application Publication No. 2005-108210) is operating in the user terminal 30, for example, the viewing status detecting unit 34 obtains the position information of the portion of the image enlarged by the user and the image identification information from the interface, and handles the position information and the image identification information as the viewing status information.

In a case where an interface for enlarging the entire image and partially displaying the image is operating in the user terminal 30, the viewing status detecting unit 34 obtains the position information as to the partially displayed image and the image identification information, and handles the position information and the image identification information as the viewing status information. In a case where the viewing status detecting unit 34 is a device that can capture eye movement, such as a camera attached to the user terminal 30, the viewing status detecting unit 34 detects the information that indicates which spot on the slide the user has been watching, based on the enlarged portion, the portion of the entire image that has been displayed over a predetermined period of time, and the view-point stop spot. Based on the detected viewing status information, the distribution information evaluating unit 25 determines the suitability of the distribution information. In the case where the user terminal 30 is equipped with a camera, the distribution information evaluating unit 25 detects the eye blinks of the user watching the slide, and then determines whether the user has been concentrating on the slide while viewing the slide. For example, if the waveform that represents the eye blinks is gentle or the eye movement rapidly decreases, the concentration power of the user is determined to have dropped.

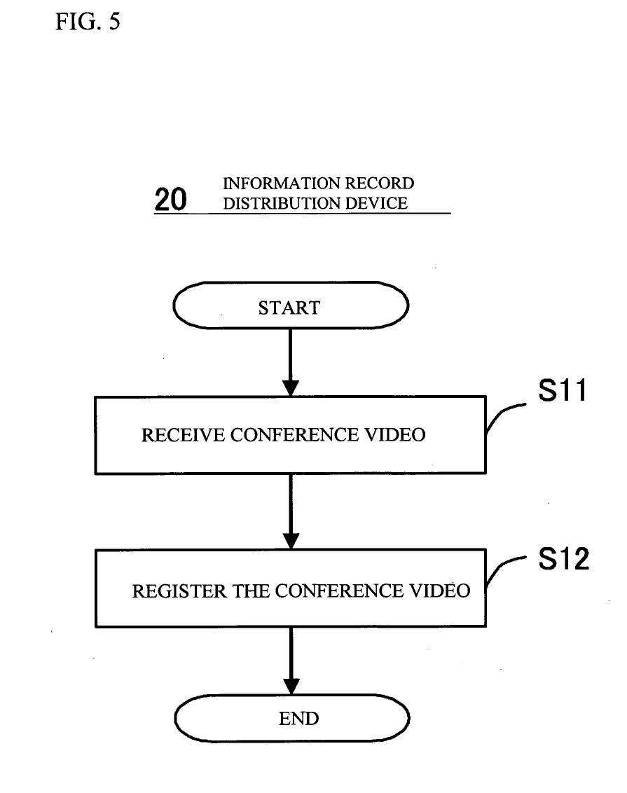

Next, the operations to be performed by the information record distribution device 20 and the user terminal 30 are described. FIG. 5 shows the flow of the operation to be performed when conference data captured by the presentation system 10 is registered in the information record distribution device 20. The information record distribution device 20 receives the conference data captured by the presentation system 10 (step S11). The information record distribution device 20 then registers the conference data in the database 27 (step S12).

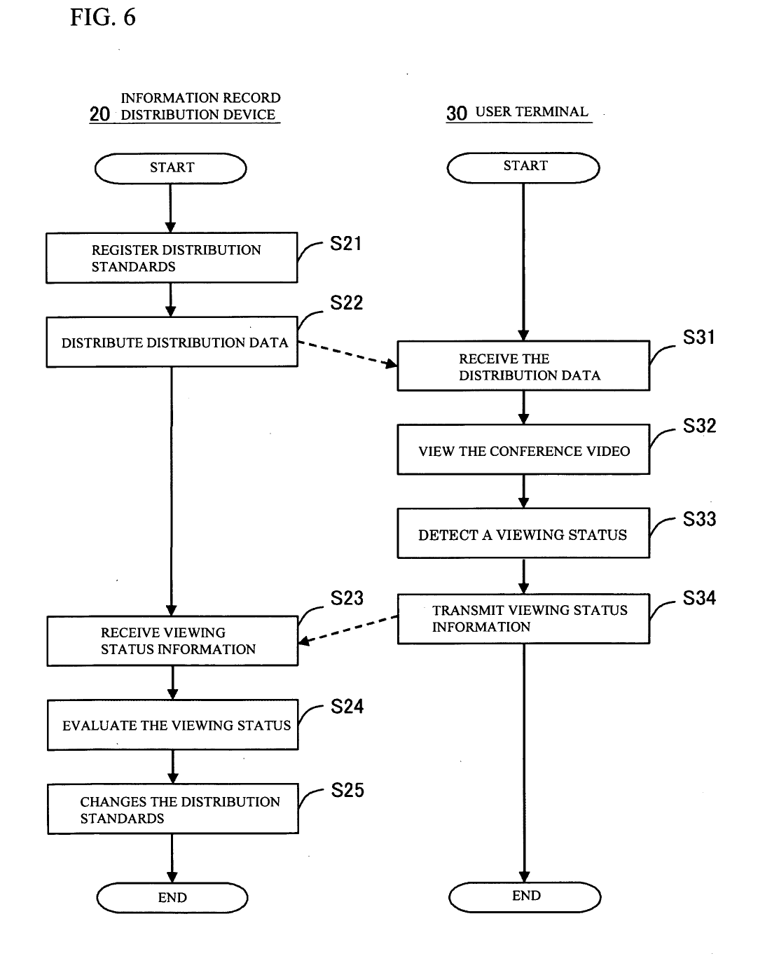

FIG. 6 shows the flow of the operations to be performed by the information record distribution device 20 and the user terminal 30. The distribution information selecting unit 22 extracts the distribution standards as to the user to whom data is to be distributed (step 21). Based on the extracted distribution standards, the distribution information selecting unit 22 reads the suitable conference data from the database 27, and distributes the distribution data to the user terminal 30 of the user (step S22). The transmission/reception unit 31 of the user terminal 30 receives the distribution data (step S31), and outputs the distribution data to the outputting unit 33 in response to a request from the user (step S32). In this manner, the user can view the distributed data.

The viewing status detecting unit 34 detects the viewing status information as to the viewer who is viewing the distribution data (step S33). The transmission/reception unit 31 of the user terminal 30 transmits the viewing status information to the information record distribution device 20 (step S34). The viewing status information receiving unit 24 receives the viewing status information transmitted from the user terminal 30 (step S23). Based on the viewing status information, the distribution information evaluating unit 25 evaluates the suitability of the distribution data (step S24). The distribution standard changing unit 26 changes the distribution standards, based on the evaluation and the portion determined to have affected the evaluation made by the distribution information evaluating unit 25 (step S25).

The distribution information evaluating unit 25 may evaluate the suitability of the distribution data, based on evaluation that is input by the user through the user terminal 30. In a case where the user obtains two or more sets of conference data as distribution data through the user terminal 30, for example, when one of the sets of conference data is determined to be very interesting conference data, the information indicating that the set of conference data is highly evaluated is sent to the distribution side. As for utterly uninteresting conference data, the information indicating that the evaluation of the conference data is low is sent to the distribution side. In such a case, the user needs to take the trouble of inputting the evaluation, but can let the distribution side know his/her preferences. Accordingly, the user does not receive distribution data in which the user is not interested, and viewing of unwanted distribution data can be avoided. The distribution information evaluating unit 25 may also change the distribution standards, based on both the evaluation by the user and automatic evaluation by the system.

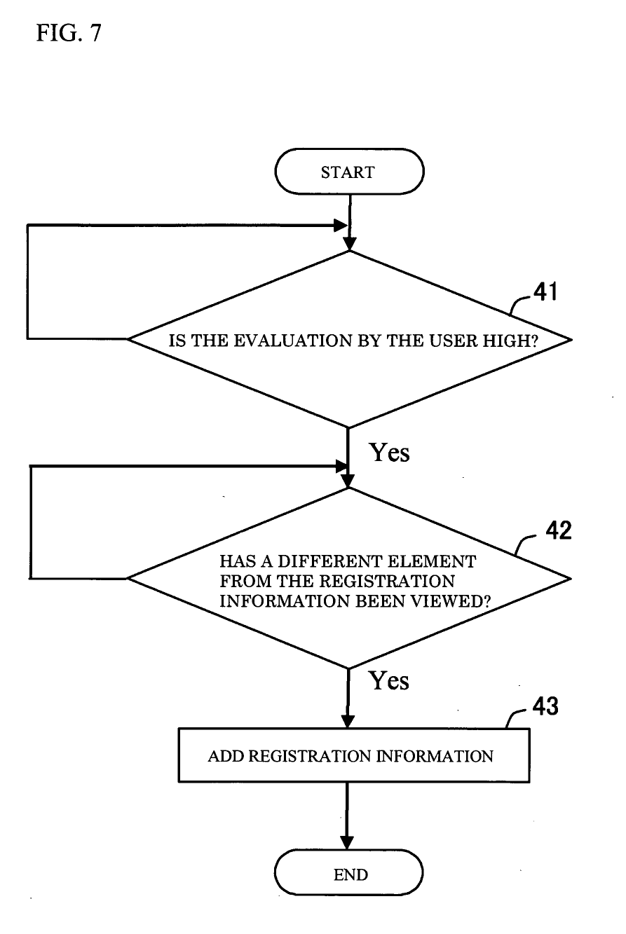

FIG. 7 is a flowchart of the operation to be performed when the user registers viewing status information. In step S41, the distribution information evaluating unit 25 determines whether the evaluation by the user is high, based on the viewing status information as to the user or the evaluation input by the user with respect to the distribution data. If the evaluation by the user is high, the distribution standard changing unit 26 determines whether a different element from any element in the registration information has been viewed in step S42. The distribution standard changing unit 26 determines whether the same element as the registered data is contained in the elements that might have affected the viewing by the user. For example, if there is an image contained in a reference material, and the image matches with the registered data or is contained in the registered data, the image is determined to be a registered element that has affected the evaluation by the user.

In a case where a different element from any element in the registration information has been viewed, the distribution standard changing unit 26 adds registration information in step S43, based on the different element. Based on the already registered registration information and the registration information added by the distribution standard changing unit 26, the distribution standard generating unit 21 generates new distribution standards. Based on the new distribution standards, the distribution information selecting unit 22 refers to the database 27 to select distribution data to be distributed.

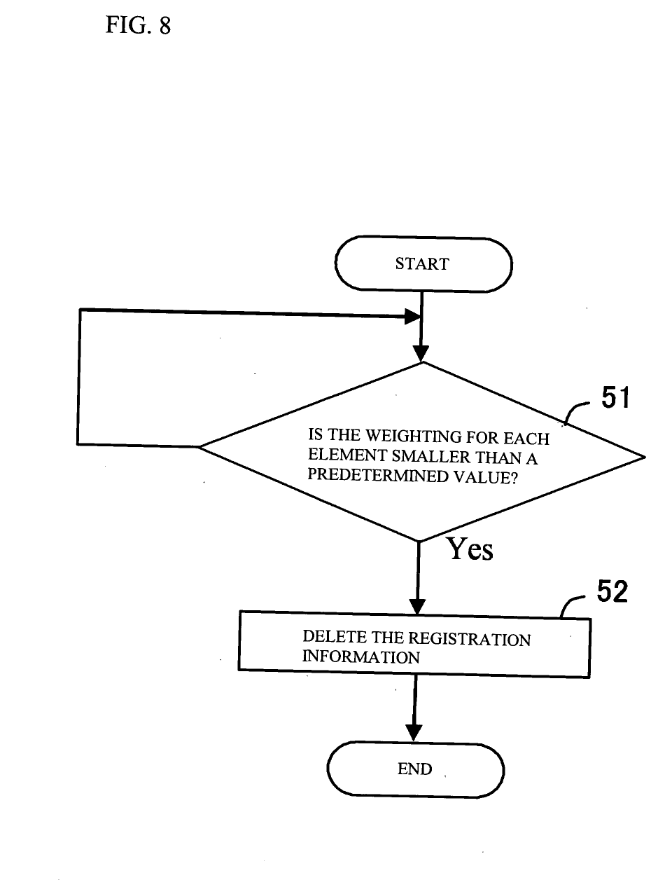

FIG. 8 is a flowchart of the operation to be performed when the user deletes the viewing status information. In step S51, the distribution standard changing unit 26 determines whether the weighting for the subject element is smaller than a predetermined value. In step S52, the distribution standard changing unit 26 deletes each element having a smaller weighting than the predetermined value, from the registration information. Based on the modified distribution standards, the distribution information selecting unit 22 refers to the database 27 to select distribution data to be distributed.

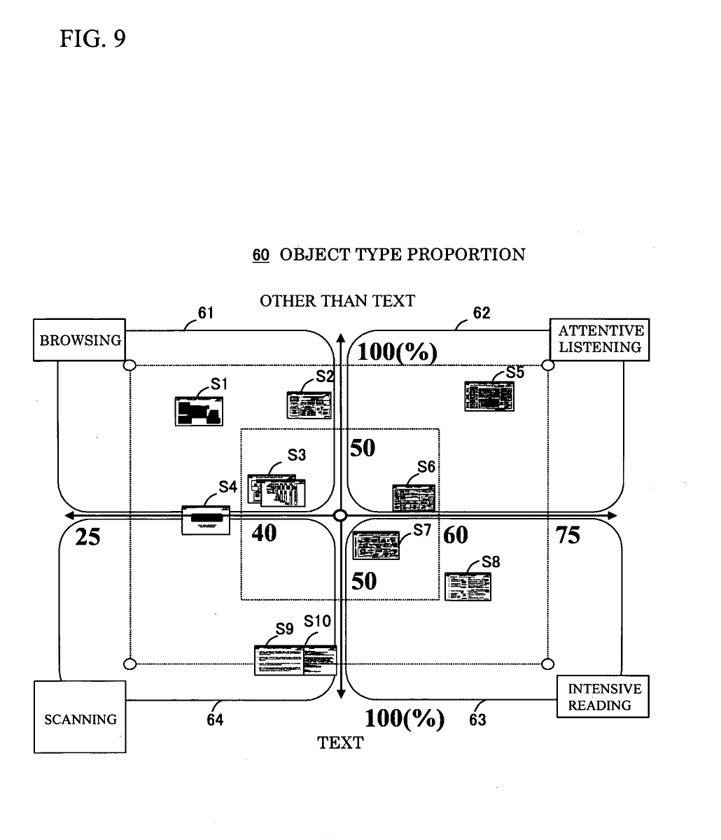

FIG. 9 illustrates the automatic evaluation by the distribution information evaluating unit. As shown in FIG. 9, an object type proportion table 60 has a browsing area 61, an attentive listening area 62, an intensive reading area 63, and a scanning area 64. The information record distribution device 20 utilizes the automatic slide classification method disclosed in Japanese Patent Application Publication No. 2006-106902, to classify slides S1 through S10 into the above four types. More specifically, the slides are classified based on the ratio of the text objects to the non-text objects in each slide, and the slide display time. The viewing status is evaluated in accordance with this table and the user status. For example, the ratio of the listening time to the reproducing time is calculated for each slide to be attentively listened. The ratio of the user viewing spots to the entire text is calculated for each slide to be intensively read. If both of the ratios are higher than predetermined values, the user is determined to have eagerly viewed the distribution data. Here, the user viewing spots are view-point stop spots, partially enlarged viewer stop points, or the screen display portions of the enlarged display UI, for example.

Thus, evaluation can be made for each slide, even if evaluation of each slide viewed by the user is not manually input.

With the information distribution system 1, the information as to conferences or lectures useful to the user can be promptly obtained. Also, changes in the user's preferences can be reflected in the information to be distributed. Information such as multimedia minutes that suits the user's preferences can be promptly obtained from the data of conferences held in various places. Further, after repeated use, information that suits the user's preferences with higher precision can be obtained.

In registering complex data such as conference records consisting of images, voices, and characters, the server can automatically analyze and selectively present each element in the data, or can register the complex data as it is. Accordingly, the information as to the complex data can be registered without any complicated process. Likewise, searching for elements or the complex data can be performed on the complex data such as conference records consisting of images, voices, and characters. Based on the user status and the contents of the distribution information, checking can be performed to determine whether the user has eagerly viewed the distribution data. Also, it is possible to determine which spot the user has been watching, based on the operation performed by the user.

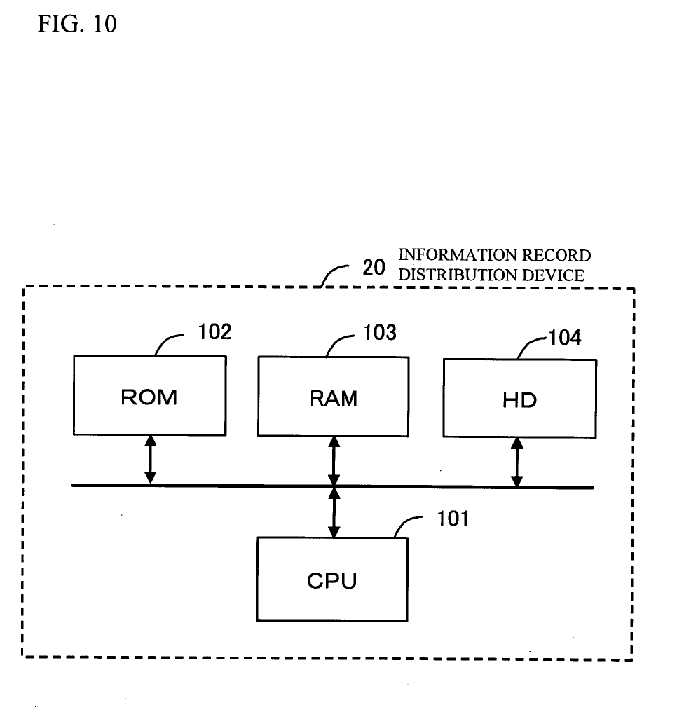

FIG. 10 illustrates the hardware structure of an information record distribution device. As shown in FIG. 10, the information record distribution device 10 includes a CPU (Central Processing Unit) 101, a ROM (Read Only Memory) 102, a RAM (Random Access Memory) 103, and a HD (Hard Disk) 104. The CPU 101 uses the RAM 103 as a working memory, and executes programs stored in the ROM 102 and the HD 104, thereby achieving each of the functions shown in FIG. 2.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The exemplary embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An information distribution system comprising:
a selecting unit that selects distribution information to be distributed to a user from stored information that is stored in compliance with distribution standards;
a distributing unit that distributes the distribution information selected by the selecting unit, to the user;
a receiving unit that receives a viewing status information that indicates a viewing status of the user who is viewing the distribution information;
an evaluating unit that evaluates the suitability of the distribution information, based on the viewing status information; and
a changing unit that changes the distribution standards, based on results of the evaluation performed by the evaluating unit.

2. The information distribution system as claimed in claim 1, further comprising
a generating unit that generates the distribution standards, based on registration information that is registered by the user.

3. The information distribution system as claimed in claim 1, further comprising
an inputting unit through which the user inputs the viewing status information.

4. The information distribution system as claimed in claim 1, further comprising
a detecting unit that detects the viewing status information.

5. The information distribution system as claimed in claim 4, wherein the detecting unit detects a period of time during which an image contained in the distribution information is displayed, the period of time being detected as the viewing status information.

6. The information distribution system as claimed in claim 4, wherein the detecting unit detects a period of time during which audio information contained in the distribution information is reproduced, the period of time being detected as the viewing status information.

7. The information distribution system as claimed in claim 4, wherein the detecting unit detects biologic information as to the user who is to view the distribution information, the biologic information being detected as the viewing status information.

8. The information distribution system as claimed in claim 4, wherein the detecting unit detects the viewing status information, based on an operating state of a terminal that is to reproduce the distribution information.

9. The information distribution system as claimed in claim 2, wherein the registration information includes at least one of image information, audio information, and text information.

10. The information distribution system as claimed in claim 2, wherein the registration information includes at least one of a keyword, a conference material, and audio information obtained by recording a conference.

11. The information distribution system as claimed in claim 2, wherein the generating unit generates the distribution standard based on an image, when the registration information registered by the user is the image.

12. The information distribution system as claimed in claim 2, wherein the generating unit generates the distribution information based on a scene detected from a moving image, when the registration information registered by the user is the moving image.

13. The information distribution system as claimed in claim 2, wherein the generating unit generates the distribution information based on at least one of a keyword, a reference material, and audio information, when the registration information registered by the user is the keyword, the reference material, and the audio information.

14. An information distribution method comprising:
selecting distribution information to be distributed to a user from stored information in compliance with distribution standards;
distributing the selected distribution information to the user;
detecting viewing status information that indicates a viewing status of the user who is viewing the distribution information;
evaluating suitability of the distribution information, based on the viewing status information; and
changing the distribution standards, based on results of the evaluation.

15. The information distribution method as claimed in claim 14, further comprising generating the distribution standards, based on registration information registered by the user.

16. A computer readable medium storing a program causing a computer to execute a process for information distribution, the process comprising:
selecting distribution information to be distributed to a user from stored information in compliance with distribution standards;
distributing the selected distribution information to the user;
detecting viewing status information that indicates a viewing status of the user who is viewing the distribution information;
evaluating suitability of the distribution information, based on the viewing status information; and
changing the distribution standards, based on results of the evaluation.
